(19) United States
(12) Patent Application Publication
(10) Pub. No.: US 2004/0211398 A1
(43) Pub. Date: Oct. 28, 2004

(54) Multiple electric motor driven air compressor

(76) Inventor: Thomas Geoffrey Knight, Miami, FL (US)

Correspondence Address: Patricia E. McQueeney, Becker & Poliakoff, P.A., 3111 Stirling Road, Fort Lauderdale, FL, 33312, US

(21) Appl. No.: 10/650,399

(22) Filed: Aug. 28, 2003

Related U.S. Application Data
(63) Continuation-in-part of application No. 10/423,590, filed on Apr. 25, 2003, now Pat. No. 6,718,955.

(51) Int. Cl. F02B 33/00

(52) U.S. Cl. 123/559.1

(57) ABSTRACT

The present invention relates to a multiple electric motor driven air compressor, for example, for gasoline or diesel engine powered vehicles.

### FIELD OF THE INVENTION

The present invention relates to a multiple electric motor driven air compressor, for example, for gasoline or diesel engine powered vehicles.

### BACKGROUND AND PRIOR ART

There is a problem with previous electrical driven air compressor designs when used as an engine supercharger, in that a single electric motor is ineffective in providing the required power needed to produce the air flow (CFM) and minimum boost pressure (at least 5 psi) that results in a noticeable horsepower (HP) increase. A single electric motor is limited by the motor's amperage draw (WATTS) and to the capacity of a vehicle's battery(s) and electrical system (i.e. battery cables).

The present invention uses existing and well known positive displacement air compressor (supercharger) theory and design, then combines that with two or more high power electric motors. The multiple electric motors have drive gears affixed to one end inside a common housing which then drives gears that are on a common shaft with the supercharger's rotors. The supercharger's rotors are turned by gears which are in contact with the gears that are fixed to the multiple electric motors mounted to a common housing. Previous electrical superchargers have used a single electric motor connected to a centrifugal compressor on a common fixed shaft.

Any engine's power output can be increased an additional amount by forcing air into the engine at pressures above atmospheric (14.7 PSI). Any given engine will experience an average one hundred percent (100%) increase in power with the addition of a second atmosphere of pressure (14.7 PSI+14.7 PSI ) to the intake manifold. To create additional pressure (boost) and additional airflow (CFM) through an engine takes considerable power. For example—a 2.0 liter 4-CYL engine that turns 6000 RPM will flow 216 CFM. To flow 50% more air (324 CFM) and 50% more pressure (7.4 PSI) would require 14 HP. 14 HP=10,444 WATTS (14 HP×746 WATTS/HP=10,444 WATTS). Using common electrical laws 10,444 WATTS is equal to 870 AMPS (WATTS=VOLTS×AMPS). Therein lies one of the problems with the prior art. It is virtually impossible to get 870 AMPS at 12 volts to an electric motor because of battery and battery cable limitations, as well as the motor. This problem is evident—a single 12 volt electric motor sufficient to make 14 HP would be extremely heavy, very large, and would make fitment an impossibility on most vehicles. One example, the General Electric 15 HP electric motor (Catalog No. V3158) weighs 340 pounds. To design and use a single 14 HP 12 volt electric motor is impractical.

The prior art has additional shortcomings in the vehicle's battery(s) and cables used to power the supercharger. Standard automotive batteries are rated using cold cranking amps (CAA). Factory supplied standard automotive batteries are typically rated at 500-700 CCA. The battery cables pose an additional limitation. The largest standard automotive battery cable is the #2 size, rated at 205 AMPS continuous or 275 AMPS momentary. 205 AMPS×12 V=2460 WATTS, or 3.3 HP. The typical automotive starter is rated at 1-1.5 HP, so the #2 cable is adequate for that application. The present positive displacement supercharger design draws 14,000 WATTS (18 HP) and 1166 AMPS at 12 volts. It is therefore impossible for a single battery and set of battery cables to provide the necessary WATTS to generate 18 HP.

### SUMMARY OF INVENTION

One purpose of the present invention is to allow for electric supercharger performance previously unattainable. A single electric motor is limited by size, weight, amperage, vehicle's battery and battery cable system. By using multiple (two or more) electric motors combined with multiple batteries and battery cables (each electric motor has a dedicated battery and cable set), the previous power limitations are overcome.

The present invention obtains the desired higher than atmospheric pressure that results in a large increase in horsepower (HP) on engines.

The present invention utilizes two (2) or more 3000+ WATT high RPM (8000+ RPM) motors, each motor having a drive gear affixed to one end, on a common mounting plate/housing with parallel shafts turning gears which turn the supercharger's rotors. It is necessary to have high supercharger rotor rotational speeds to create 5+ PSI boost pressure on smaller engines. Larger engines would of course require a larger supercharger and additional motors or more powerful motors.

One embodiment of the present invention provides a compact design of three electric motors making the complete supercharger fifteen (15) to sixteen (16) inches long, eight (8) inches in diameter, and weighing approximately 38 pounds. This is similar in size to the currently available automotive superchargers.

One embodiment of the present invention incorporates the use of three separate batteries to power the supercharger unit—one battery per electric motor, with one complete set of battery cables per battery/electric motor. The three sets of battery cables are to be larger than production battery cables—2/0 cables rated at 325 AMPS (continuous use) per cable. The 2/0 cables have a momentary rating of 450 AMPS (30 seconds) per cable, allowing for 1350 AMPS or 16,200 WATTS. (450 AMPS×3 batteries×12 volts).

One embodiment of this invention uses two or more electric motors and gears to power a roots type positive displacement supercharger.

One embodiment of this invention use two or more electric motors and gears to power a screw type positive displacement supercharger.

One embodiment of this invention uses two or more electric motors and gears/pulleys to power a centrifugal supercharger.

By using two or more motors and a variety of supercharger components, a system can be made for a specific application—such as a motorcycle, snowmobile, watercraft, up to a semi-tractor trailer truck or large industrial stationary engine. In addition, a standard size could be produced to cover a large segment of the most popular vehicles. Because the horsepower and watts would stay constant, a smaller engine could receive higher boost pressures (PSI), while a larger engine would receive more air flow (CFM) but less boost pressure (PSI). Known fan laws state that if horse power (HP) is constant, and pressure (PSI) drops, then air flow (CFM) increases. Conversely, as boost pressure (PSI) increases then air flow (CFM) is reduced. (HP=P×CFM).

Another object of the present invention is to make available, at a reasonable cost, a high performance electric supercharger. To this end, the majority of components are already available. With suitable modification, the supercharger housings and supercharger rotors are standard supercharger components from Eaton, Magnuson Products, Autorotor, Whipple, etc. The electric motors can be high amperage 6+ Volt aftermarket motor modified for this application from Delco-Remy, Nippon-Denso, etc. The drive gears can be, but are not limited to steel, aluminum, or any composite. The battery cables can be standard high AMP 2/0 welding cable, and the batteries can be automotive type available at any auto parts store.

U.S. Pat. No. 2,839,038 describes using one (1) or two (2) electric motors to turn a centrifugal supercharger. U.S. Pat. No. 5,224,459 by Middlebrook uses internal gears with two parallel shafts powered by the vehicle's engine crankshaft to power a centrifugal supercharger. This requires engine oil to be supplied to the gears and bearings. U.S. Pat. No. 5,638,796 by Adams III uses a 10 HP, 50-100 Volt, 60,000 RPM electric motor to power a centrifugal supercharger. As seen by the provided explanations, 10 HP is not sufficient to make adequate boost pressure (PSI) and airflow (CFM). In addition, the cost of the electric motor, controller, voltage step-up transformer, and the required additional batteries to produce 50-100 volts make that design impractical. However, this invention solves that problem.

### BRIEF DESCRIPTION OF THE DRAWINGS

FIG. 1 shows a side perspective of one embodiment of the multiple electric motor powered supercharger of the present invention.

FIG. 2 provides an exploded perspective of one embodiment of the multiple electric motor driven supercharger of the present invention.

FIG. 3 provides a side view of one embodiment of the multiple electric motor driven supercharger of the present invention with three electric motors.

FIG. 4 shows an end view of one embodiment of the multiple electric motor driven supercharger of the present invention with three electric motors.

FIG. 5 shows the gear arrangement of one embodiment of the multiple electric motor driven supercharger with three electric motors.

### DETAILED DESCRIPTION

Throughout the specification and claims, the terms “air compressor” and “supercharger” are used interchangeably and refer to the component that supplies air under pressure to the cylinders of an internal combustion engine.

Throughout the specification and claims, the terms “boost” and “pressure” are used interchangeably and refer to the amount of air pressure produced by the supercharger.

Throughout the specification and claims, the terms “gears” and “pulleys” are used interchangeably to refer to a part, such as a disc, wheel, or section of a shaft, for supporting, guiding, or transmitting force.

Throughout the specification and claims, the term standard 2 gauge wire indicates a battery cable rated at 205 amps continuous, or 275 amps momentary.

Throughout the specification and claims, the term standard 2/0 gauge wire indicates a battery cable rated at 325 amps continuous, or 450 amps momentary.

Throughout the specification and claims,

“pounds per square inch” are depicted as “psi,”

“horsepower” is depicted as “hp,”

“revolutions per minute” are depicted as “rpm,” and

“1,000” is depicted as “K.”

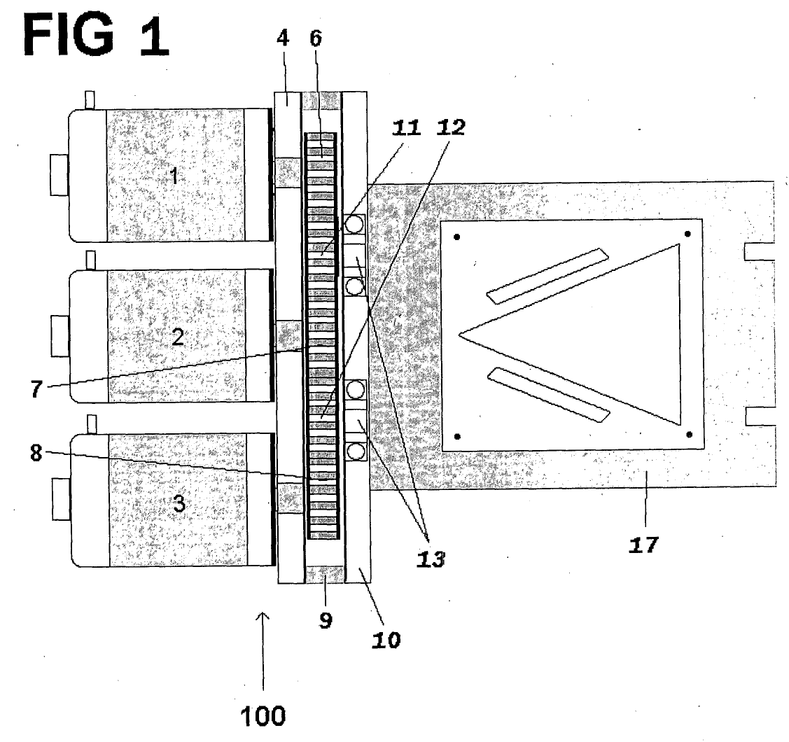

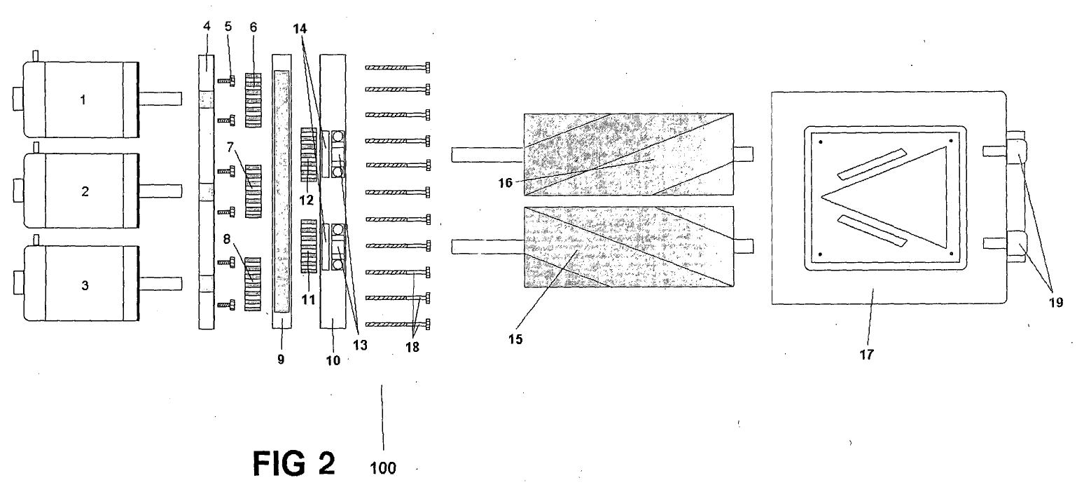

FIGS. 1 through 5 provide several embodiments of the present invention, in which like parts are indicated by like numbers. As the details are the clearest in the exploded perspective of FIG. 2, the details of one embodiment will be described using that Figure as reference.

FIG. 2 shows an exploded perspective of one embodiment of the multiple electric motor driven supercharger (100) of the present invention. The multiple electric motor driven supercharger (100) contains three electric motors (1, 2, 3). These electric motors (1, 2, 3) can be any high amp (6 volt or more) electric motors, modified for this application. Each electric motor (1, 2, 3) is connected to a direct current energy source (not shown). The direct current energy source (not shown) can be any object capable of producing approximately twelve (12) volts, such as a standard twelve-volt battery. Each electric motor (1, 2, 3) should be capable of rotational speeds of 8,000 RPM or higher.

The three electric motors (1, 2, 3) of the multiple electric motor driven centrifugal air compressor (100) shown in FIG. 2 are attached to three gears (6, 7, 8) through a gear housing plate (4). The three gears (6, 7, 8) can be connected to the three electric motors (1, 2, 3) by bolts, press fitting, or any suitable means. The electric motors (1, 2, 3) are mounted to the gear housing plate (4) by electric motor mounting bolts (5). However, any known connection mechanism can be used to connect the electric motors (1, 2, 3) to the gear housing plates (4).

The gears (6, 7, 8) are protected from the environment by the combination of gear housing plate (4), gear housing spacer (9), and supercharger rotor bearing plate (10). Supercharger rotor bearing plate (10) is connected to gear housing spacer (9) and gear housing plate (4) by gear housing bolts (18). However, as described for the electric motor mounting bolts (5), any known connection mechanism can be used. The gear housing plate (4), gear housing spacer (9) and the supercharger rotor bearing plate (10) are comprised of normal engine materials, including, but not limited to aluminum, steel or composites. Depending upon the application, the gear housing plate (4), gear housing spacer (9), and the supercharger rotor bearing plate (10) comprise an average total width of 8 inches and an average total thickness of 2 inches.

Electric motor (1) drives gear (6). Electric motor (2) drives gear (7). Electric motor (3) drives gear (8). Gears (6, 7, and 8) drive supercharger rotor gears (11, 12). The gears (6, 7, 8, 11, 12) are comprised of aluminum, steel, or any suitable composite. In the alternative, gears (6, 7, 8) can drive supercharger rotor gears (11, 12) by means of one or more two-sided drive belts (not shown). In that embodiment, the gears (6, 7, 8) can be cog drive or grooved pulleys. The drive belt can be V-belt, multi-groove V-belt, toothed timing belt, or any suitable belt for this application. The belt can be constructed of rubber, urethane, fiberglass stranded, or any suitable materials.

Supercharger gear (11) is connected to supercharger rotor (15) and supercharger gear (12) is connected to supercharger rotor (16). Supercharger rotors (15, 16) are supported at one end by supercharger rotor shaft bearings (13), which are mounted in supercharger rotor bearing plate (10). Supercharger rotors (15, 16) are supported at the opposite end by supercharger rotor housing bearings (19), which are mounted in supercharger rotor housing (17).

Electric motors (1, 2, 3) power supercharger rotors (15, 16) of the multiple electric motor driven supercharger (100) of the present invention. Supercharger rotors (15, 16) are powered by the electric motors (1, 2, 3) connected to gears (4, 5, 6), which contact and mesh with supercharger gears (11, 12). The resultant power available to multiple electric motor driven supercharger (100) is greater than experienced by previous superchargers.

FIG. 1 provides a side perspective of one embodiment of the multiple electric motor powered supercharger (100) of the present invention.

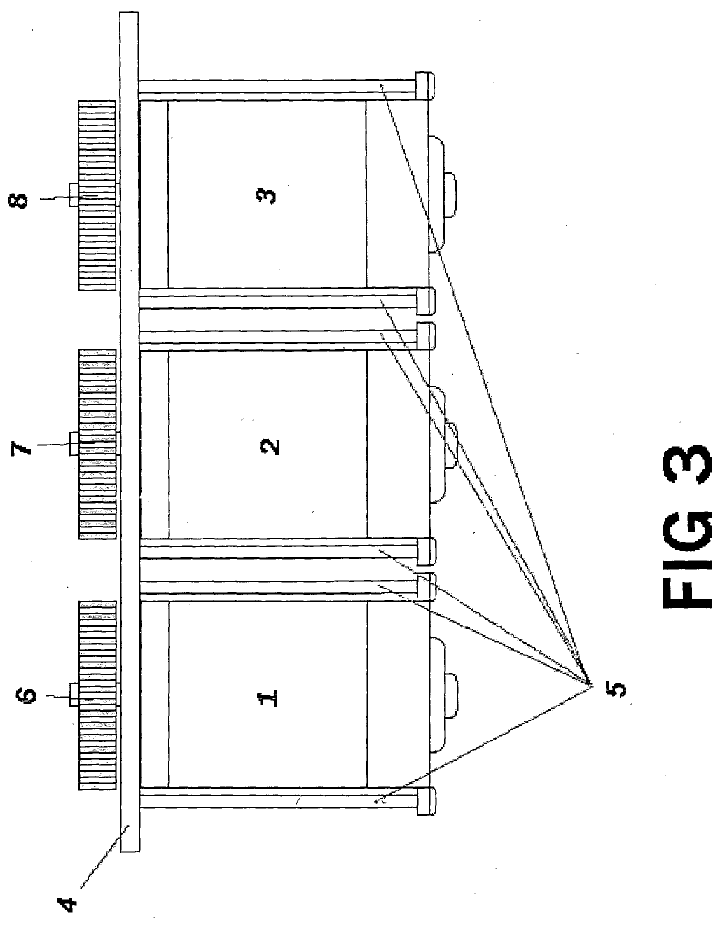

FIG. 3 provides a side view of one embodiment of the multiple electric motor driven supercharger (100) of the present invention containing three electric motors (1, 2, 3), gears (6, 7, 8), gear mounting plate (4), and the electric mounting bolts (5).

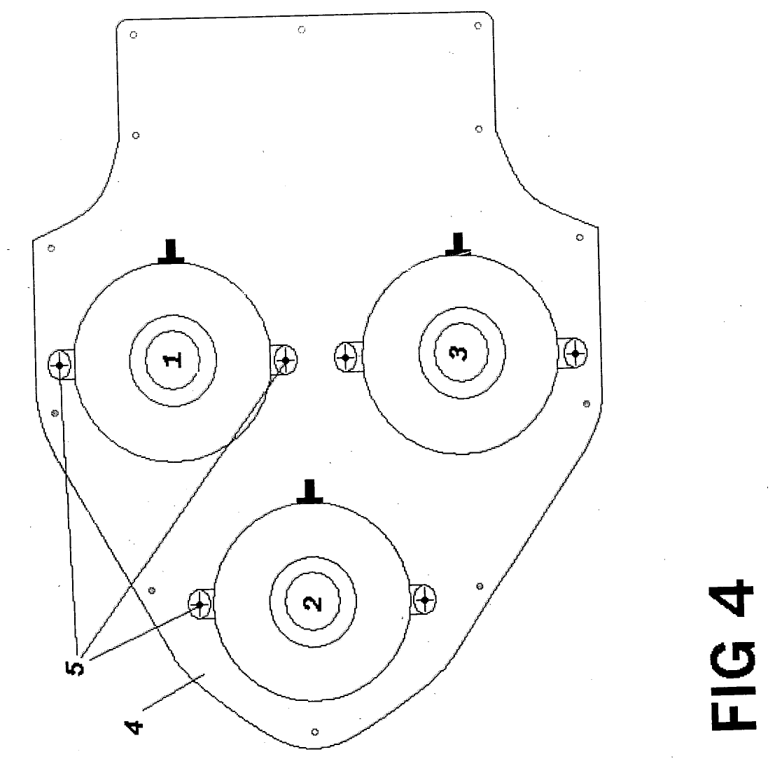

FIG. 4 provides an end view of one embodiment of the multiple electric motor driven supercharger (100) of the present invention with three electric motors (1, 2, 3) and gear mounting plate (4).

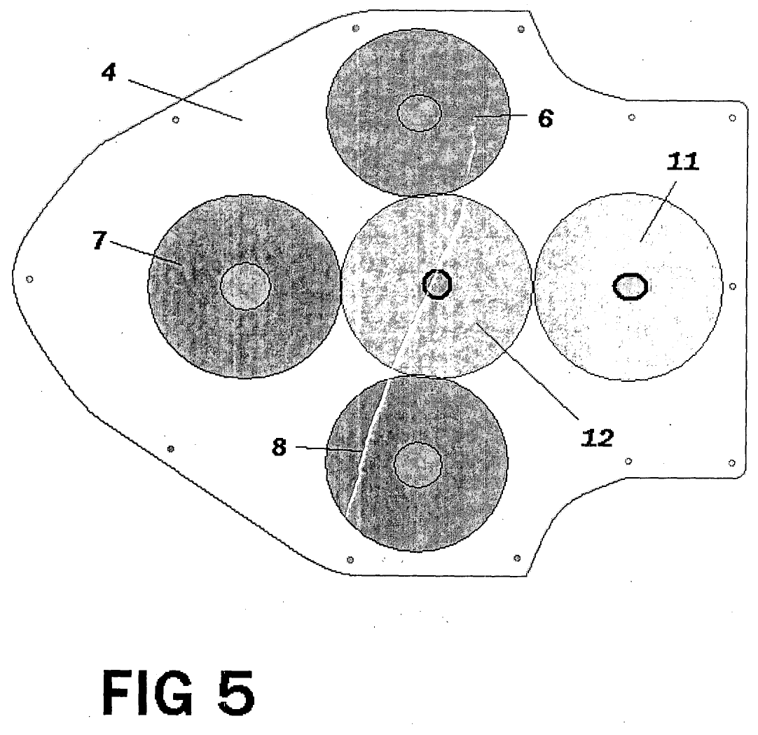

FIG. 5 provides an internal view of the gear arrangement of one embodiment of the multiple electric motor driven supercharger (100) of the present invention with three gears (6, 7, 8), supercharger rotor gears (11, 12) and gear mounting plate (4).

The Figures have been provided for exemplary purpose only. It is to be understood that the invention is not limited to the embodiments disclosed in the Figures, but is intended to cover various modifications and equivalent arrangements included within the spirit of the invention, which are set forth in the appended claims, and which scope is to be accorded the broadest interpretation so as to encompass all such modifications and equivalent structures.

I claim:

1. A method for increasing power to an air compressor, said method comprising utilizing more than one electric motor to power said air compressor.

2. The method of claim 1 wherein each of said more than one electric motor comprises a direct current energy source.

3. The method of claim 2 wherein said direct current energy source is a battery.

4. A method for increasing power to an air compressor, said method comprising connecting a compressor shaft of said air compressor to a housing containing two or more pulleys driven by two or more electric motors.

5. An electric motor driven air compressor comprising
A. housing that contains two or more pulleys and one drive belt;
B. two or more electric motors,
C. an air compressor;
wherein each of said two or more electric motors is individually connected to a direct current energy source,
wherein each of said two or more electric motors drives one of said two or more pulleys,
wherein said two or more pulleys drive said one drive belt,
and wherein said one drive belt powers said air compressor.

6. The electric motor driven air compressor of claim 5 wherein said direct current energy source is a battery.
